(19) United States
(12) Patent Application Publication
(10) Pub. No.: US 2002/0018171 A1
(43) Pub. Date: Feb. 14, 2002

(54) Liquid crystal device

(76) Inventors: Yasufumi Asao, Atsugi-shi (JP); Takeshi Togano, Chigasaki-shi (JP); Ryuichiro Isobe, Atsugi-shi (JP)

Correspondence Address: FITZPATRICK CELLA HARPER & SCINTO, 30 ROCKEFELLER PLAZA, NEW YORK, NY, 10112, US

(21) Appl. No.: 09/766,608

(22) Filed: Jan. 23, 2001

(30) Foreign Application Priority Data
Jan. 24, 2000 (JP) 014409/2000
Jan. 19, 2001 (JP) 010975/2001

(51) Int. Cl. C09K 19/02

(52) U.S. Cl. 349/172

(57) ABSTRACT

A liquid crystal device is constituted by a pair of substrates at least one of which is provided with a uniaxial alignment axis, and a chiral smectic liquid crystal disposed between the substrates to form a plurality of pixels arranged in rows and columns. Each pixel is provided with a switching element and an electrode for applying a voltage to the liquid crystal via the switching element. A matrix of signal lines comprising scanning signal lines and data signal lines is so arranged that each scanning signal line is disposed along a row of the pixels so as to connect a row of the switching elements provided to the row of the pixels and each data signal line is disposed along a column of the pixels so as to connect a column of the switching elements provided to the column of the pixels. The liquid crystal exhibits a phase transition series on temperature decrease of isotropic phase, cholesteric phase and chiral smectic C phase or of isotropic phase and chiral smectic C phase. The uniaxial alignment axis is arranged to form an angle of at least 10 degrees with respect to both the scanning and data signal lines so that the liquid crystal is aligned to form smectic layers of which a layer extension direction forms an angle of at most 10 degrees with respect to either one of the scanning and data signal lines.

### FIELD OF THE INVENTION AND RELATED ART

The present invention relates to a liquid crystal device for use in light-valves for flat-panel displays, projection displays, printers, etc.

As a type of a nematic liquid crystal display device used heretofore, there has been known an active matrix-type liquid crystal device wherein each pixel is provided with an active element (e.g., a thin film transistor (TFT)).

As a nematic liquid crystal material used for such an active matrix-type liquid crystal device using a TFT, there has been presently widely used a twisted nematic (TN) liquid crystal as disclosed by M. Schadt and W. Helfrich, “Applied Physics Letters”, Vol. 18, No. 4 (Feb. 17, 1971), pp. 127-128.

In recent years, there has been proposed a liquid crystal device of In-Plain Switching mode utilizing an electric field applied in a longitudinal direction of the device or of Vertical Alignment mode, thus improving a viewing angle characteristic being poor in the conventional liquid crystal displays.

Accordingly, there are various liquid crystal modes suitable for the TFT-type liquid crystal device using the nematic liquid crystal material. In any mode however, the resultant nematic liquid crystal display device has encountered a problem of a slow response speed of several ten milliseconds or above.

In order to improve the response characteristic of the conventional types of nematic liquid crystal devices, several liquid crystal devices using a specific chiral smectic liquid crystal, such as a ferroelectric liquid crystal of a short pitch-type, a polymer-stabilized ferroelectric liquid crystal or an anti-ferroelectric liquid crystal showing no threshold (voltage) value have been proposed. Although, these devices have not been put into practical use sufficiently, it has been reported that a high-speed responsiveness on the order of below millisecond is realized.

With respect to the chiral smectic liquid crystal device, our research group has proposed a liquid crystal device as in U.S. patent application Ser. No. 09/338426 (filed Jun. 23, 1999) wherein a chiral smectic liquid crystal has a phase transition series on temperature decrease of isotropic liquid phase (Iso)-cholesteric phase (Ch)-chiral smectic C phase (SmC*) or Iso-SmC* (SmA (smectic A phase)-less phase transition series) and liquid crystal molecules are monostabilized at a position inside an edge of a virtual cone. During the phase transition of Ch-SmC* or Iso-SmC*, liquid crystal molecular layers are uniformly oriented or aligned in one direction, e.g., by applying a DC voltage of one polarity (+ or −) between a pair of substrates to improve high-speed responsiveness and gradation control performance and realize a high-luminance liquid crystal device excellent in motion picture image qualities with a high mass-productivity. The liquid crystal device of this type may advantageously be used in combination with active elements such as a TFT because the liquid crystal material used has a relatively small spontaneous polarization compared with those used in the conventional chiral smectic liquid crystal devices.

As described above, in a sense of solving the problem of the conventional nematic liquid crystal devices, i.e., improvement in response speed, the realization of a practical liquid crystal device using a chiral smectic liquid crystal, particularly a monostabilized liquid crystal device as proposed by our research group, is expected for used in advanced displays with high-speed responsiveness and good gradation display performance in combination.

In the above-mentioned monostabilized liquid crystal device, however, a liquid crystal is required to be aligned along a surface of an active matrix substrate having thereon TFTs (active element), thus resulting in an occurrence of alignment defect lines within pixels due to irregularity in thickness (stepwise surface shape) caused by TFTs per se and/or gate and source lines connected with gates and sources of TFTs, respectively, for driving TFTs. Accordingly, the resultant liquid crystal device is liable to lower a uniform alignment characteristic, thus remarkably decreasing a contrast ratio to deteriorate display performances o the device a a display device. For this reason, such an liquid crystal device is essentially required to suppress an occurrence of alignment defect due to the above-mentioned surface irregularity of the active matrix substrate (provided with TFTs).

### SUMMARY OF THE INVENTION

A principal object of the present invention is to provide a liquid crystal device having solved the above-mentioned problems.

A specific object of the present invention is to provide an active matrix-type liquid crystal device using a chiral smectic liquid crystal capable of suppressing an occurrence of alignment defect due to irregularity in thickness (stepwise surface shape) caused by TFTs and/or gate and source lines connected thereto.

Another object of the present invention is to provide a chiral smectic liquid crystal device providing an improved contrast.

According to the present invention, there is provided a liquid crystal device, comprising: a pair of substrates at least one of which is provided with a uniaxial alignment axis, and a chiral smectic liquid crystal disposed between the substrates to form a plurality of pixels arranged in rows and columns;

each pixel being provided with a switching element and an electrode for applying a voltage to the liquid crystal via the switching element,

a matrix of signal lines comprising a plurality of scanning signal lines and a plurality of data signal lines being so arranged that each scanning signal line is disposed along a row of the pixels so as to connect a row of the switching elements provided to the row of the pixels and each data signal line is disposed along a column of the pixels so as to connect a column of the switching elements provided to the column of the pixels, and

the liquid crystal exhibiting a phase transition series on temperature decrease of isotropic phase, cholesteric phase and chiral smectic C phase or of isotropic phase and chiral smectic C phase, wherein

the uniaxial alignment axis is arranged to form an angle of at least 10 degrees with respect to both the scanning signal lines and the data signal lines so that the liquid crystal is aligned to form smectic layers of which a layer extension direction forms an angle of at most 10 degrees with respect to either one of the scanning and data signal lines.

In the liquid crystal device, the liquid crystal may preferably have an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle, said tilting angles providing maximum tilting angles β1 and β2 formed under application of the voltages of the first and second polarities, respectively, satisfying β1>β2, preferably β1≧5×β2.

In the above liquid crystal device, the liquid crystal may preferably have an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, but is not substantially tilted from the monostable alignment state in the other direction when supplied with a voltage of a second polarity opposite to the first polarity. Further, the liquid crystal may preferably have a helical pitch in its bulk state larger than a value two times a cell thickness, and the switching elements may preferably comprise thin film transistors.

As mentioned above, in the case where a TFT-type (active matrix-type) liquid crystal device is prepared by using a chiral smectic liquid crystal having a specific (SmA-less) phase transition series, alignment defects due to the stepwise wiring of TFTs have been frequently caused to occur, thus lowering a contrast. This may be attributable to an obstacle to formation of uniform smectic molecular layers because of the presence of the stepwise surface portion of active matrix substrate. Accordingly, the occurrence of alignment defects cannot be obviated as long as the active matrix substrate has a stepwise (surface unevenness) portion by the presence of TFTs and their wiring lines. The alignment defects result from disorder of smectic layer structure. According to our study, even in the case where a rubbing treatment (uniaxial alignment treatment) is effected only to a counter substrate free from a stepwise (uneven) portion, when the other active matrix substrate has the stepwise portion, a smectic layer structure of liquid crystal molecules is disordered to cause alignment defects. In other words, in order to suppress the alignment defects, e.g., an improvement in rubbing uniformity over an entire display area cannot become an essential solution.

In the present invention at least one of a pair of substrates is subjected to uniaxial alignment treatment (e.g., rubbing) in a direction forming an angle of at least 10 degrees with respect to extension directions of scanning signal lines and data signal lines leading to a stepwise portion on an active matrix substrate with active elements (e.g., TFT) so that a smectic layer structure of liquid crystal molecules is formed such that a layer normal direction (LND) (and also a smectic layer (extension or formation) direction (SLD) of chiral smectic liquid crystal molecules forms an angle of at most 10 degrees with respect to either one of a group of scanning signal lines and a group of data signal lines. As a result, the extension direction of either one of the groups of scanning and data signal lines are substantially parallel to or intersects with the smectic layer normal (or formation) direction (LND or SLD) at a small crossing angle (i.e., at most 10 degrees), whereby alignment defects caused due to stepwise wiring portion do not obliquely cross each pixel and an amount thereof is also reduced to improve a contrast of a resultant liquid crystal device.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIGS. 1A-1C are schematic views for illustrating positional relationships among directions of scanning signal line, data signal line, rubbing, normal of smectic layers, and smectic layer formation in Ch phase, SmC* phase under DC(+) and SmC* phase under DC(−), respectively.

FIGS. 2A and 2B are schematic views for illustrating in detail the positional relationships shown in FIG. 1B (DC(+)SmC* phase) and FIG. 1C (DC(−)SmC* phase), respectively.

FIG. 3 is a schematic plan view of an active matrix substrate of the liquid crystal device of the present invention connected with drive circuits.

FIG. 4 is a schematic sectional view of one-pixel portion of the liquid crystal device shown in FIG. 3.

FIG. 5 is an equivalent circuit of the one-pixel portion shown in FIG. 4.

FIG. 6 is a time chart of driving waveforms for the liquid crystal device shown in FIGS. 3-5.

### DESCRIPTION OF THE PREFERRED EMBODIMENTS

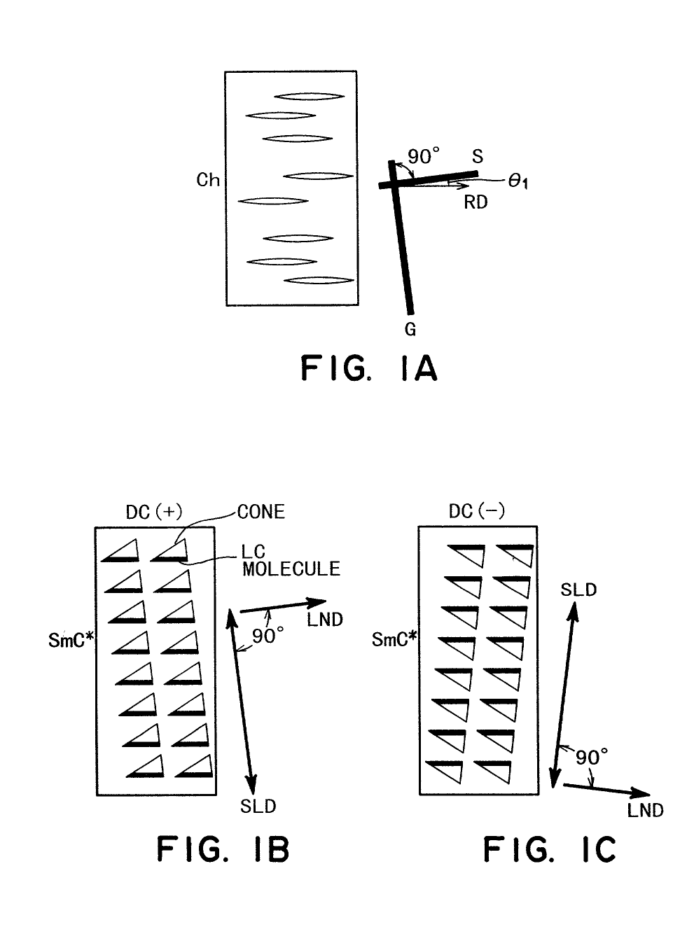

Hereinbelow, preferred embodiments of the liquid crystal device of the present invention will be described with reference to FIGS. 1-6.

FIGS. 1A-1C illustrate a preferred embodiment of the present invention. Specifically, FIG. 1A shows a positional relationship between cholesteric liquid crystal molecules and some directional factors including a uniaxial alignment direction (e.g., rubbing direction RD), gate (scanning) electrode (G) extension direction, source (data) electrode (S) extension direction. FIG. 1B shows a positional relationship between chiral smectic liquid crystal molecules and their directional factors including a layer normal direction (LND) (a direction of a normal to smectic layers) and a smectic layer (formation) direction (SLD) when a chiral smectic liquid crystal is supplied with a voltage (DC voltage) of a positive polarity (DC(+)) during a phase transition from Ch (cholesteric phase) to SmC* (chiral smectic C phase) (e.g., at temperatures of Tc±2° C. where Tc is a phase transition temperature from Ch to SmC*) and FIG. 1C shows a corresponding positional relationship when the liquid crystal is supplied with a negative polarity voltage (DC voltage: DC(−)) during a phase transition from Ch to SmC*.

Referring to FIG. 1A, gate or scanning electrodes (scanning signal lines) (S) and source or data electrodes (data signal liens) (G) are arranged to intersect each other at right angles on one of a pair of substrates (not shown) to provide some projections to the surface of the substrate.

A rubbing direction (RD) is deviated from the source electrode (S) to form a prescribed angle θ₁ therebetween. The rubbing direction (RD) is a direction of (average) uniaxial alignment axis formed by subjecting at least one of alignment films (provided to a pair of substrates) to uniaxial alignment treatment such as rubbing. For instance, when two uniaxial alignment axes cross each other at a prescribed angle, the rubbing direction is determined as a direction of a bisector of the two uniaxial alignment axes.

In FIG. 1, a rectangular region shows a state where a liquid crystal disposed between the pair of substrates assumes Ch (cholesteric phase), and each elongated ellipse represents a cholesteric liquid crystal molecule. Each elongated ellipse has a long axis substantially aligned with the rubbing direction (RD).

In the present invention, the (deviation) angle θ₁ between the rubbing direction (RD) and the source line (electrode) (S) extension direction is set to be at least 10 degrees.

In this embodiment, the angle θ₁ is taken as a positive value when the rubbing direction (RD) is deviated from the source line (electrode) (S) extension direction in a clockwise direction and taken as a negative value in a counterclockwise direction. The deviation angle θ₁ may be determined based on the gate line (electrode) (G) extension direction in place of the source line (S) extension direction.

When the liquid crystal in Ch as shown in FIG. 1A is caused to change its state to SmC* while being supplied with DC(+) and DC(−), resultant (chiral) smectic liquid crystal molecules are aligned to form layer structures shown in FIGS. 1B and 1C, respectively. Referring to each of these figures, two groups (smectic molecular layers) of smectic liquid crystal molecules (indicated by solid lines) each capable of moving on a cone are aligned in parallel to each other and somewhat inclined at a prescribed angle from a long side of a rectangular region including the smectic layers. The parallel two groups of smectic liquid crystal molecules are formed in a smectic layer (formation) direction (SLD) and a direction of a normal to smectic layers is indicated by LND (layer normal direction).

As is understood from FIGS. 1B and 1C, all the chiral smectic liquid crystal molecules are placed in one of two optically stable states in each case (SmC*/DC(+) or SmC*/DC(−)) in a direction substantially aligned with the rubbing direction. However, the inclination direction of smectic layers in SmC* given by the application of positive polarity DC voltage (DC(+)) as shown in FIG. 1B is opposite to that of smectic layers in SmC* given by the application of DC(−) as shown in FIG. 1C with respect to long sides of the rectangular regions. This positional relationship is also applied to that between the SLDs (smectic layer directions) of FIGS. 1B and 1C and that between the LNDs (layer normal directions) perpendicular to the SLDs, respectively.

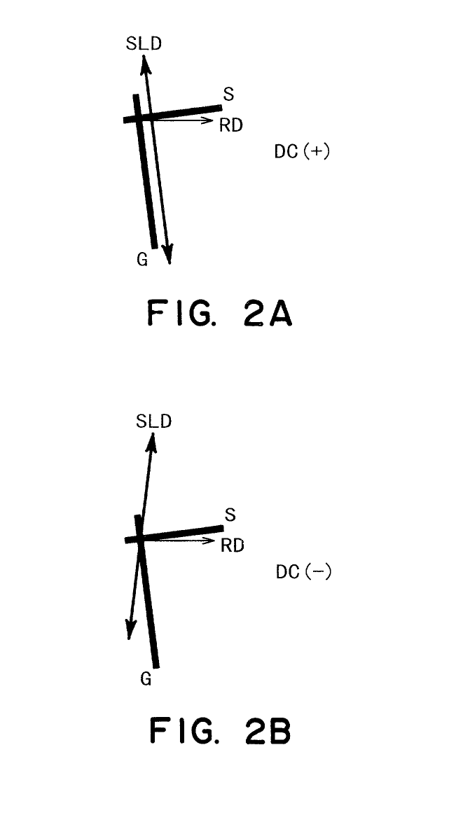

In this embodiment, it is preferred to form smectic layer (in SmC*) through the application of DC(+) during the Ch-SmC* phase transition (FIG. 1B) since the SLD (or LND) of smectic layers is substantially aligned with the gate line (G) (or source line (S)) extension direction as specifically shown in FIG. 2A as described above.

On the other hand, in the case of FIG. 1C, (DC(−)), the SLD (or LND) of smectic layers is largely deviated from the gate line (G) (or source line (S)) at an angle of above 10 degrees as specifically shown in FIG. 2B.

In the present invention, if a chiral smectic liquid crystal used assumes a state as shown in FIG. 1B by applying a negative (−)DC voltage during Ch-SmC* phase transition and a state as shown in FIG. 1C by applying a positive (+)DC voltage based on its characteristics, it is preferred to form smectic layers (in SmC*) through the application DC(−) since the SLD is substantially aligned with the gate line (G) extension direction similarly as in the case shown in FIG. 2A.

In the present invention, by appropriately setting the rubbing direction (RD) so as to form an angle of at least 10 degrees with respect to the source line (S) (or gate line (G)) extension direction it is preferred to completely aligned the SLD (or LND) with either one of the gate line (G) extension direction (or the source line (S) extension direction) (e.g., as shown in FIG. 2A), thus effectively improving a contrast. Even if the SLD is not completely aligned with the gate line (G) extension direction, when a deviation angle therebetween is within ±10 degrees based on the gate line (G) extension direction, it is possible to improve a contrast.

On the other hand, when the SLD is largely deviated from the gate line (G) extension direction (deviation angle of above 10 deg.) as shown in FIG. 2B, it is difficult to improve a contrast.

As described above, in the present invention, it is important that the rubbing direction (RD) is set in a prescribed range (specifically a range providing a deviation angle of at least ±10 deg. with respect to the source line (S) extension direction and the gate line (G) extension direction and that a polarity of a voltage (DC voltage) applied during the Ch-SmC* phase transition is appropriately selected so s to substantially aligned the SLD (or LND) with either one of the gate line (G) extension direction and the source line (S) extension direction (i.e., so as to provide a deviation angle of the SLD (LND) with the gate line (G) (or source line (S)) extension direction of at most 10 deg.), thus effectively improving a contrast.

In the liquid crystal device of the present invention, the chiral smectic liquid crystal used has a phase transition series on temperature decrease of Iso-Ch-SmC* or Iso-SmC*, i.e., SmA (smectic A phase)-less phase transition series. When one-polarity (positive (+) or negative (−)) DC voltage is applied between the pair of substrates during the phase transition of Ch to SmC*, liquid crystal molecules in SmC* are placed in a state providing only either one of two smectic layer (formation) directions (SLD) giving different layer normal directions (LND) to provide a certain angle formed between an average uniaxial aligning axis and the resultant smectic layer normal direction. Further, under no voltage application, liquid crystal molecules are stabilized inside a virtual cone edge for the liquid crystal molecules, thus being placed in a SmC* alignment state wherein a memory characteristic is not developed (i.e., a non-memory state), i.e., in a monostabilized state under no voltage application.

The chiral smectic liquid crystal may preferably be a liquid crystal composition prepared by appropriately blending a plurality of liquid crystal materials selected from hydrocarbon-type liquid crystal materials containing a biphenyl, phenylcyclohexane ester or phenyl-pyrimidine skeleton; naphthalene-type liquid crystal materials; and fluorine-containing liquid crystal materials.

The liquid crystal composition as the chiral smectic liquid crystal used in the liquid crystal device may preferably comprise at least two compounds each represented by the following formulas (1), (2), (3) and (4).

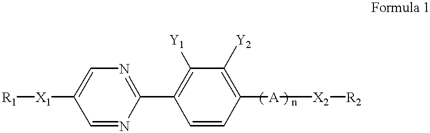

wherein A is

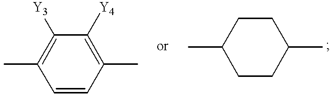

R1 and R2 are independently a linear or branched alkyl group having 1-20 carbon atoms optionally having a substituent; X1 and X2 are independently a single bond O, COO or OOC; Y1, Y2, Y3 and Y4 are independently H or F; and n is 0 or 1.

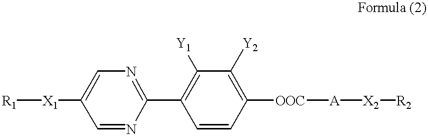

wherein A is

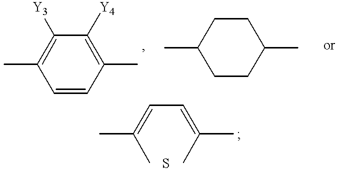

R1 and R2 are independently a linear or branched alkyl group having 1-20 carbon atoms optionally having a substituent; X1 and X2 are independently a single bond O, COO or OOC; and Y1, Y2, Y3 and Y4 are independently H or F.

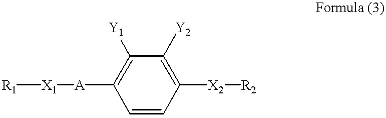

wherein A:

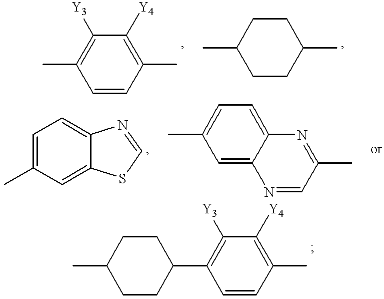

R1 and R2 are independently a linear or branched alkyl group having 1-20 carbon atoms optionally having a substituent X1 and X2 are independently a single bond O, COO or OOC; and Y1, Y2, Y3 and Y4 are independently H or F.

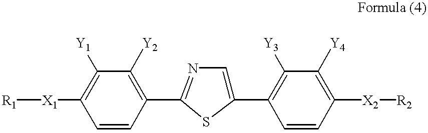

wherein R1 and R2 are independently a linear or branched alkyl group having 1-20 carbon atoms optionally having a substituent; X1 and X2 are independently a single bond, O, COO or OOC; and Y1, Y2, Y3 and Y4 are independently H or F.

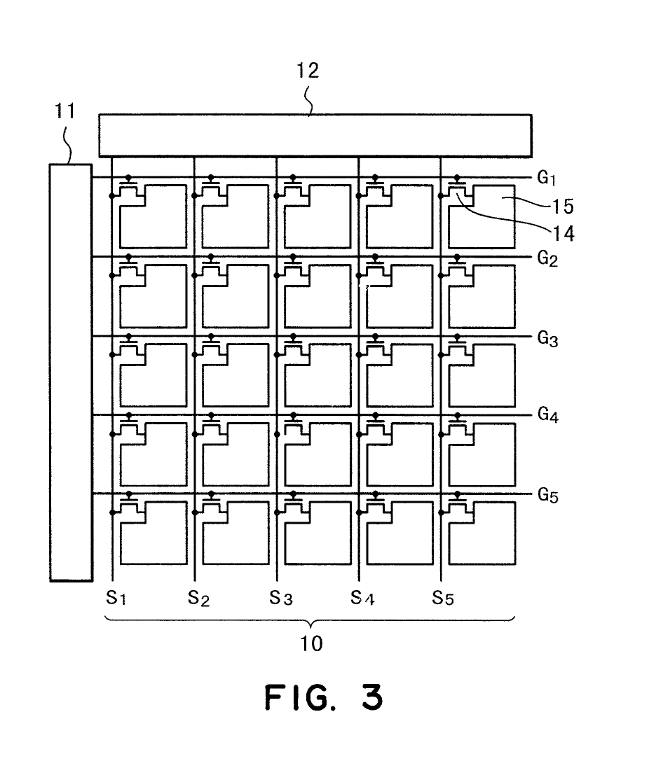

Hereinbelow, an embodiment of the liquid crystal device according to the present invention will be described with reference to FIGS. 3-6.

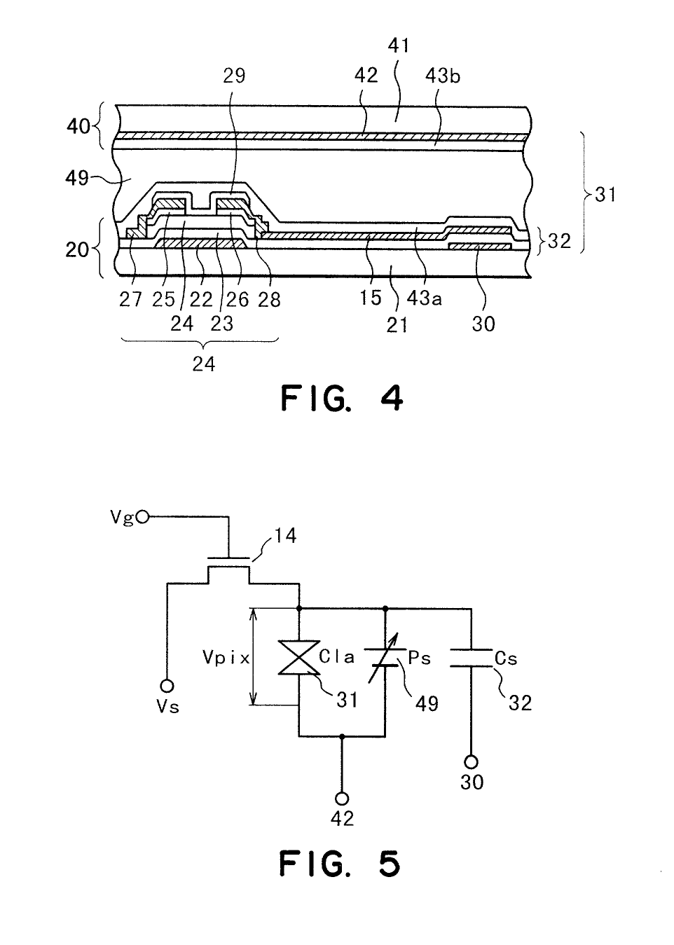

FIG. 3 is a schematic plan view illustrating an arrangement of an active matrix substrate and peripheral drive circuits in a liquid crystal device according to this embodiment of the present invention. FIG. 4 is a schematic partial sectional view showing an organization of one pixel region of the liquid crystal device and FIG. 5 is an equivalent circuit for one pixel region shown in FIG. 4.

In this embodiment, as a switching element, an amorphous silicon thin film transistor (a-Si TFT) is used.

Referring to FIGS. 3-5, a liquid crystal panel 10 includes a plurality of pixels and each pixel is formed by an active matrix substrate 20 including a substrate 11, a pixel electrode 15, a TFT 14 including a gate electrode 22 formed thereon, a gate insulating film 23, an a-Si layer 24, n⁺a-Si layers 25 and 26, a source electrode 27, a drain electrode 28 and a channel protection film 29, a holding (storage) capacitor electrode 30 giving a holding (storage) capacitance (Cs) 32 and an alignment control layer 43a; a counter substrate 40 including a transparent substrate 41, a common electrode 42 and an alignment control layer 43b; and a liquid crystal layer 49 giving a liquid crystal capacitance (C_{lc}) 31 disposed between the active matrix substrate 20 and the counter substrate 40.

Thus, in the structure shown in FIG. 4, the liquid crystal layer 49 assuming a chiral smectic phase and having a spontaneous polarization (Ps) is disposed between the active matrix substrate 20 having thereon the TFT 14 and the pixel electrode 15 and the counter substrate 40 provided with the common electrode 42 to provide a liquid crystal capacitance (C_{lc}) 31.

Regarding the active matrix substrate 20, shown in FIG. 4 a TFT 14 is formed on a transparent substrate 21 of glass, plastic, etc., by successively forming a gate (scanning) electrode 22 connected to the gate (scanning signal) lines G1, G1, . . . shown in FIG. 3, an insulating film (gate insulating film) 23 and an a-Si layer 24 of, e.g., SiNx. On the a-Si layer 24, a source electrode 27 and a drain electrode 28 are disposed in separation from each other and via n⁺a-Si layers 25 and 26, respectively. A source electrode 27 is connected to one of source (data signal) lines S1, S2, . . . shown in FIG. 3, and the drain electrode 28 is connected to a pixel electrode 15 comprising a transparent conductor film, such as an ITO film. The a-Si layer 24 of the TFT 14 is further coated with a channel protection film 29. The TFT is turned on when a gate pulse is applied to the gate electrode 22 at the time of scanning selection of the corresponding gate line.

In the active matrix substrate 20, a holding capacitance (Cs) 32 can be formed by a structure sandwiching a portion of the insulating film 23 (also covering the gate electrode) with the pixel electrode 15 and a holding capacitor electrode 30 disposed on the substrate 21 in parallel with the liquid crystal capacitance (C_{lc}) 31 given by the liquid crystal layer 29 as shown in FIG. 4. In case where a large area of the holding capacitor electrode 30 is required, the holding capacitor electrode 30 can be formed of a transparent conductor film, such as an ITO film, so as not to lower the aperture ratio.

The electrodes formed on the active matrix substrate 20 and the counter substrate 40 may be coated, as desired, with insulating layers (not shown) of materials such as SiO_{2, TiO}₂, Ta₂O₃, etc., e.g., for preventing a short circuit therebetween.

Further, alignment control layers 43a and 43b are formed, respectively, in contact with the liquid crystal layer 49 so as to control the alignment state thereof. At least one of the alignment control layers 43a and 43b has been subjected to a uniaxial alignment treatment (e.g., rubbing). Such aligning control layers 43a and 43b may be formed by application in a solution state of an organic material, such as polyimide, polyamide imide, polyamide, polyvinyl alcohol, etc., or a precursor thereof, followed by rubbing, or may be formed as an oblique vapor deposition film of an inorganic material, such as an oxide such as SiO or a nitride, formed by vapor deposition onto a substrate in an oblique direction at a prescribed angle from the substrate.

By selecting, e.g., the material and condition for treatment (such as uniaxial aligning treatment) of the alignment control films 43a and 43b, the molecules of the liquid crystal layer 49 are aligned at a controlled pretilt angle (an angle formed by liquid crystal molecules in the vicinities of a boundary with the alignment control layer with respect to the alignment control layer).

In the case where the alignment control layers 43a an 43b are both subjected to a uniaxial aligning treatment, the directions of the uniaxial aligning treatment (particularly, rubbing directions) for the two layers can be set to be parallel or parallel and opposite to each other (anti-parallel) or so as to cross each other (e.g., at an angle of at most 45 deg.), depending on the liquid crystal material used.

The active matrix substrate 20 and the counter substrate 40 are disposed opposite to each other with a spacer (not shown) disposed therebetween. The spacer is used to determine the gap (cell thickness) between the substrates 20 and 40, and may for example comprise silica beads. The cell thickness thus-determined may have an optimum range varying depending on the liquid crystal material used and may preferably be set within a range of 0.3-10 μm so as to develop a uniform uniaxial alignment characteristic and the alignment state where the liquid crystal molecules are aligned to assume an average molecular axis in substantial agreement with an average of the aligning treatment axes. It is further preferred that the cell thickness is appropriately adjusted so that the helical pitch in a bulk state of the chiral smectic liquid crystal is at least two times the cell thickness.

It is also possible to disperse adhesive particles (not shown) comprising a resinous material, such as epoxy resin, in addition to the spacer (beads) so as to enhance the adhesion between the substrates 20 and 40 and improve the impact resistance of the liquid crystal layer 49 assuming a chiral smectic phase.

Referring to FIG. 3, in a panel unit 10 corresponding to a liquid crystal device, gate lines G1, G2, . . . corresponding to scanning signal lines which extend laterally and are connected to a scanning signal driver 11, and source lines S1, S2, . . . corresponding to data signal lines which extend vertically and are connected to a data signal driver 12, are disposed to intersect each other while being insulated from each other. At each intersection of the gate lines G1, G2, . . . and the source lines Sl, S2, . . ., a TFT (switching element) 14 is disposed and a pixel electrode 15 is connected thereto to form a pixel. FIG. 3 shows only 5×5 pixel regions for convenience of illustration, but a larger number of pixel regions are actually included. As a switching element (active element), it is also possible to use a polycrystalline silicon (p-Si) TFT or an MIM (metal-insulator-metal) element instead of TFT.

The gate lines G1, G2, . . . are connected to gate electrodes 22 of TFTs 14, the source lines S1, S2, . . . are connected to source electrodes 27 of the TFTs 14, and the pixel electrodes 15 are connected to drain electrodes 28 of the TFTs 14. Based on the structure, the gate lines G1, G2 . . . are sequentially selected by the scanning signal driver 11 to be supplied with a gate voltage. In synchronism with the sequential scanning selection of the gate lines, data signal voltages corresponding to data written at respective pixels are supplied from the data signal driver 12 via the source liens S1, S2, . . . and TFTs 14 on the selected gate line to the corresponding pixel electrodes 15.

The liquid crystal device of the present invention may be used as a color liquid crystal device by providing one of the pair of substrates 20 and 40 with a color filter comprising color filter segments (color portions) of at least red (R), green (G) and blue (B). It is also possible to effect a full-color display successively switching a light source comprising R light source, G light source and B light source emitting corresponding color light fluxes to effect color mixing in a time sequential manner.

The liquid crystal device according to this embodiment is of a light-transmission type such that the pair of substrates 20 and 40 are sandwiched between a pair of polarizers (not shown) to optically modulate incident light (e.g., issued from an external light source) through one of the substrates to be passed through the other substrate. The liquid crystal device of the present invention may be modified into a reflection-type liquid crystal device by providing a reflection plate to either one of the substrates 20 and 40 or using a combination of one of the substrates per se formed of a reflective material or with a reflecting member thereon and the other substrate provided with a polarizer outside thereof, thus optically modulating incident light and reflected light and causing the reflected light to pass through the substrate on the light incident side.

The liquid crystal device having the above-mentioned cell structure can be prepared by using a chiral smectic liquid crystal material while adjusting the composition thereof, and further by appropriate adjustment of the liquid crystal material treatment, the device structure including a material, and a treatment condition for alignment control films 43a and 43b. As a result, in a preferred embodiment of the present invention, the liquid crystal material is placed in such an alignment state that liquid crystal molecules are aligned to provide an average molecular axis to be mono-stabilized in the absence of an electric field applied thereto and, under application of voltages of one polarity (a first polarity), are tilted in one direction from the average molecular axis under no electric field to provide a tilting angle which varies continuously from the average molecular axis of the monostabilized position depending on the magnitude of the applied voltage. On the other hand, under application of voltages of the other polarity (i.e., a second polarity opposite to the first polarity), the liquid crystal molecules are tilted in the other direction from the average molecular axis under no electric field depending on the magnitude of the applied voltages, thus realizing a halftone (gradation) display. Further, in this embodiment a maximum tilting angle β1 obtained under application of the first polarity voltages based on the monostabilized position is substantially larger than a maximum tilting angle β2 formed under application of the second polarity voltages, i.e., β1>β2, more preferably β1≧5×β2.

The liquid crystal may also has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, but is not substantially tilted from the monostable alignment state in the other direction when supplied with a voltage of a second polarity opposite to the first polarity.

In the present invention, by using the above-mentioned liquid crystal device in combination with a drive circuit for supplying gradation signals to the liquid crystal device, it is possible to provide a liquid crystal display apparatus capable of effecting an analog-like gradational display according to active matrix driving scheme based on amplitude modulation in combination with the above-mentioned alignment characteristic such that under voltage application, a resultant tilting angle varies continuously from the monostabilized position of the average molecular axis (of liquid crystal molecules) and a corresponding emitting light quantity continuously changes, depending on the applied voltage.

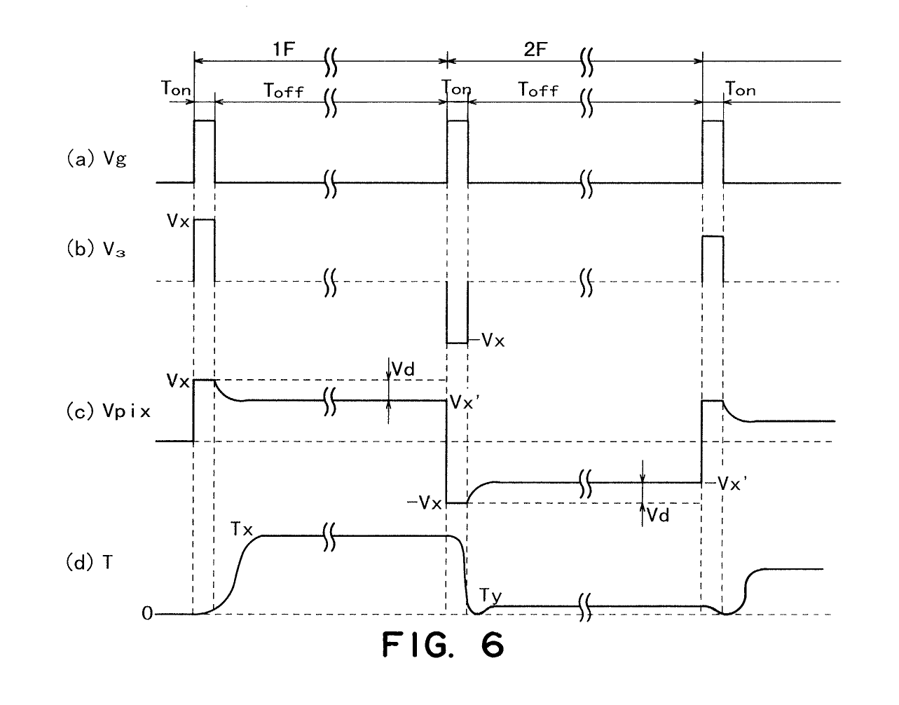

Next, an example of an ordinary active matrix driving method utilizing the liquid crystal device having the active matrix substrate (plate) and the above-mentioned alignment characteristic (β1>β2 or β1≧5×β2) will be described with reference to FIG. 6 in combination with FIGS. 3-5.

In the active matrix driving method used in the present invention described below, as shown in FIG. 6, for each pixel, one frame period for displaying a prescribed information is divided into a plurality of field periods (e.g., 1F and 2F in FIG. 6) each for a prescribed image.

In each of the field periods 1F and 2F, a prescribed transmitted (emitted) light quantity depending on a prescribed image information for each field period is obtained. Further, in each frame period, an average of the transmitted light quantities in the field periods 1F and 2F is obtained to provide a prescribed image.

FIG. 6 shows at (a) a voltage waveform applied to one gate line (electrode) 22 (e.g., G1 shown in FIG. 3) (as a scanning signal line) connected with each pixel.

In the liquid crystal device driven by the active matrix driving method, the gate lines G1, G2, . . . shown in FIG. 3 are selected, e.g., in a line-sequential manner in each of the field periods 1F and 2F. At this time, each gate electrode 22 connected with a corresponding gate line is supplied with a prescribed gate voltage Vg in a selection period Tₒₙ of each field period (e.g., 1F), thus placing the TFT 14 in an “ON” state. In a non-selection period T_{off} (of, e.g., the field period 1F) corresponding to a period in which other gate lines are selected, the gate electrode 22 is not supplied with the gate voltage Vg, thus placing the TFT 14 in an “OFF” state (high-resistance state).

FIG. 6 shows at (b) a voltage waveform applied to one source line (electrode) 27 (e.g., S1 shown in FIG. 3) (as a data signal line) connected to the pixel concerned.

When the gate electrode 22 is supplied with the gate voltage Vg in the selection period Tₒₙ of each field period 1F or 2F as shown at (a) of FIG. 6, in synchronism with this voltage application, a prescribed source voltage (data signal voltage) Vs having a prescribed potential providing a writing data (pulse) to the pixel concerned is applied to a source electrode 27 through the source line connected with the pixel based on a potential Vc of a common electrode 42 as a reference potential.

More specifically, in the first field period 1F constituting one frame period, a positive-polarity source voltage Vs having a potential Vx (based on a reference potential Vc) providing a desired optical state or display data (transmittance) based on a voltage-transmittance (V-T) characteristic for the liquid crystal used is applied to the source electrode 27 concerned.

At this time, the TFT 14 is in an “ON” state, whereby the positive-polarity source voltage Vx applied to the source electrode 27 is supplied to a pixel electrode 15 via a drain electrode 28, thus charging a liquid crystal capacitor (Clc) 31 and a holding capacitor (Cs) 32. As a result, the potential of the pixel electrode 15 becomes a level equal to that of the positive-polarity source (data signal) voltage Vx.

Then, in a subsequent non-selection period T_{off}, for the gate line on the pixel concerned, the TFT 14 is in an “OFF” (high-resistance) state. At this time (in T_{off} of 1F), in the liquid crystal cell, the liquid crystal capacitor (Clc) 31 and the holding capacitor (Cs) 32 retain the electric charges therein, respectively, charged in the selection period Tₒₙ to keep the (positive-polarity) voltage Vx. As a result, the liquid crystal layer 49 of the pixel concerned is supplied with the voltage Vx through the first field period 1F to provide thereat a desired optical state (transmitted light quantity) depending on the voltage Vx.

In the case where the response time of the liquid crystal is larger than the gate “ON” period, a switching of the liquid crystal is effected in the non-selection period T_{off} (the gate “OFF” period) after the completion of the charging of the liquid crystal capacitor (Clc) 31 and the holding capacitor (Cs) 32. In this case, the electrical charges stored in the capacitors are reduced due to inversion of spontaneous polarization Ps to provide (positive-polarity) voltage Vx′ smaller than the voltage Vx by a voltage Vd as a pixel voltage Vpix applied to the liquid crystal layer 49 as shown at (c) of FIG. 6.

Thereafter, in the second (subsequent) field period 2F, a negative-polarity source voltage Vs (=−Vx) having an identical potential (absolute value) to but a polarity opposite to the source voltage Vs (=Vx) applied in the first field period IF is applied to the source electrode 27 concerned.

At this time, the TFT 14 is in an “ON” state, whereby the negative-polarity source voltage −Vx is supplied to a pixel electrode 15, thus charging a liquid crystal capacitor (Clc) 31 and a holding capacitor (Cs) 32. As a result, the potential of the pixel electrode 15 becomes a level equal to that of the negative-polarity source (data signal) voltage −Vx.

Then, in a subsequent non-selection period T_{off}, for the gate line on the pixel concerned, the TFT 14 is in an “OFF” (high-resistance) state. At this time (in T_{off} of 2F), in the liquid crystal cell, the liquid crystal capacitor (Clc) 31 and the holding capacitor (Cs) 32 retain the electric charges therein, respectively, charged in the selection period Tₒₙ to keep the (negative-polarity) voltage −Vx. As a result, the liquid crystal layer 49 of the pixel concerned is supplied with the voltage −Vx through the second field period 2F to provide thereat a desired optical state (transmitted light quantity) depending on the voltage −Vx.

In the case where the response time of the liquid crystal is larger than the gate “ON” period, a switching of the liquid crystal is effected in the non-selection period Toff (the gate “OFF” period) after the completion of the charging of the liquid crystal capacitor (Clc) 31 and the holding capacitor (Cs) 32. In this case, similarly as in the first period 1F, the electrical charges stored in the capacitors are reduced due to inversion of spontaneous polarization Ps to provide (negative-polarity) voltage −Vx′ smaller than the voltage −Vx by a voltage Vd as a pixel voltage Vpix applied to the liquid crystal layer 49 as shown at (c) of FIG. 6.

FIG. 6 shows at (d) an example of an actual optical response at the pixel concerned.

As shown at (c) of FIG. 6, an applied voltage through two field periods 1F and 2F comprises the positive-polarity voltage Vx′ in the first field period 1F and the negative-polarity voltage −Vx′ (having the same amplitude (absolute value) as Vx′) in the second field period 2F. In the first field period IF, as shown at (d) of FIG. 6, a higher luminance (or transmitted light quantity) Tx is obtained in the first field period 1F but in the second field period 2F, a lower luminance (or transmitted liquid quantity) Ty which is closer to zero but a non-zero value because the relationship of β1>β2 (β1≧5×β2) is satisfied.

As described above, in the active matrix driving method, it becomes possible to effect a good gradational display based on a high-speed responsiveness of the chiral smectic liquid crystal. In addition, a gradational display of a prescribed level at each pixel is continuously performed by dividing one frame period into a first field pixel IF providing a higher transmitted light quantity and a second field period 2F providing a lower transmitted light quantity, thus resulting in a timewise aperture rate of at most 50% to improve a human-sensible high-speed responsiveness with respect to motion picture display. Further, in the second field period 2F providing the lower transmitted light quantity, the resultant transmitted light quantity is not completely zero due to a slight switching (inversion) performance of liquid crystal molecules, thus ensuring a certain human-sensible luminance through the entire frame period.

In the above embodiment, the polarity of the voltage (Vx or −Vx) is changed alternately for every field period (1F or 2F) (i.e., polarity-inversion for each field period), whereby the voltage actually applied to the liquid crystal layer 49 is continuously changed in an alternating manner to suppress a deterioration of the liquid crystal material used even in a continuous display operation for a long period.

As described above, in the above active matrix driving method, in each frame period consisting of two field periods 1F and 2F, a resultant transmitted light quantity corresponds to an average of Tx and Ty. Accordingly, in order to obtain a further higher transmitted light quantity in each frame period, it is preferred to apply a source (data signal) voltage Vs providing a transmitted light quantity higher than Tx in the first field period 1F by a prescribed level.

The liquid crystal device of the present invention may be applicable to a full-color liquid crystal display apparatus using the liquid crystal device in combination with a plurality of color light sources of at least red (R), green (G) and blue (B) without using a color filter, as desired, thus effecting color mixing in a multiplexing manner.

Hereinbelow, the present invention will be described more specifically based on Examples.

### EXAMPLE 1

A chiral smectic liquid crystal composition LC-1 was prepared by mixing the following compounds in the indicated proportions.

| Structural formula | wt. % |
|---|---|
| 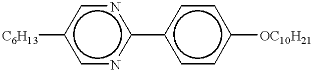 | 11.55 |
| 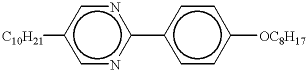 | 11.55 |
| 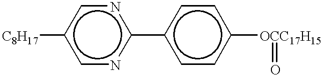 | 7.70 |
| 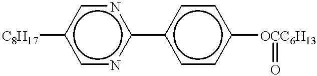 | 7.70 |
| 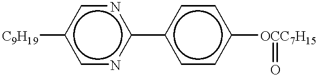 | 7.70 |
| 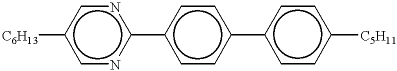 | 9.90 |
| 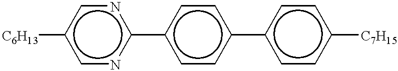 | 9.90 |
| 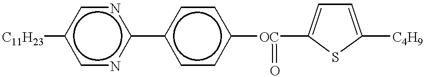 | 30.0 |
| 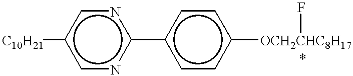 | 4.00 |

The thus-prepared liquid crystal composition LC-1 showed the following phase transition series and physical properties.

Phase transition temperature (° C.)

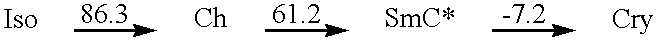

(Iso: isotropic phase, Ch: cholesteric phase, SmC*: chiral smectic C phase, Cry: crystal phase)

Spontaneous polarization (Ps): 2.9 nC/cm (30° C.)

Tilt angle \mathring{H}: 23.3 degrees (30° C.), AC voltage=100 Hz and ±12.5 V, cell gap =1.4 μm)

Layer inclination angle δ: 21.6 degrees (30° C.)

Helical pitch (SmC*): at least 20 μm (30° C.)

The values of phase transition temperatures, spontaneous polarization Ps, tilt angle \mathring{H}, and layer inclination angle δ in smectic layer referred to herein are based on values measured according to the following methods.

Measurement of Phase Transition Temperatures

The phase transition temperatures of the liquid crystal composition LC-1 were measured by using a differential scanning calorimeter (“DSC Pyris 1”, available from Perkin Elmer Co.) after the liquid crystal composition LC-1 was kept at 100° C. for 1 min., cooled to −30° C. at a rate of 5° C./min., kept at −30° C. for 5 min.

As apparent from the phase transition series shown above, the liquid crystal composition LC-1 did not assume smectic A phase (SmA).

Measurement of Spontaneous Polarization Ps

The spontaneous polarization Ps was measured according to “Direct Method with Triangular Waves for Measuring Spontaneous Polarization in Ferroelectric Liquid Crystal”, as described by K. Miyasato et al (Japanese J. Appl. Phys. 22, No. 10, pp. L661-(1983)).

Measurement of Tilt Angle \mathring{H}

A liquid crystal device was sandwiched between right angle-cross nicol polarizers and rotated horizontally relative to the polarizers under application of an AC voltage of ±12.5 V to ±50 V and 1 to 100 Hz between the upper and lower substrates of the device while measuring a transmittance through the device by a photomultiplier (available from Hamamatsu Photonics K.K.) to find a first extinct position (a position providing the lowest transmittance) and a second extinct position. A tilt angle \mathring{H} was measured as half of the angle between the first and second extinct positions.

Measurement of Liquid Crystal Layer Inclination Angle δ

The method used was basically similar to the method used by Clark and Largerwal (Japanese Display '86, Sep. 30-Oct. 2, 1986, p.p. 456-458) or the method of Ohuchi et al (J.J.A.P., 27 (5) (1988), p.p. 725-728). The measurement was performed by using a rotary cathode-type X-ray diffraction apparatus (available from MAC Science), and 80 μm-thick microsheets (available from Corning Glass Works) were used as the substrates so as to minimize the X-ray absorption with the glass substrates of the liquid crystal cells.

A blank cell was prepared in the following manner.

A pair of 1.1 mm-thick glass substrates each provided with a 700 Å-thick transparent electrode of ITO film was provided except that one of the pair of glass substrate was formed in an active matrix substrate provided with a plurality of a-Si TFTs and a silicone nitride (gate insulating) film and the other glass substrate was provided with a color filter including color filter segments of red (R), green (G) and blue (B).

The thus prepared blank cell (active matrix cell) having a structure as shown in FIG. 4 had a picture area size of 10.4 inches including a multiplicity of pixels (800×600×RGB).

On each of the transparent electrodes (of the pair of glass substrates), a polyimide precursor (“SE7992”, mfd. by Nissan Kagaku K.K.) was applied by spin coating and pre-dried at 80° C. for 5 min., followed by hot-baking at 200° C. for 1 hour to obtain a 500 Å-thick polyimide film.

Each of the thus-obtained polyimide film was subjected to rubbing treatment (as a uniaxial aligning treatment) with a nylon cloth under the following conditions to provide an alignment control film.

Rubbing roller: a 10 cm-dia. roller about which a nylon cloth (“NF-77”, mfd. by Teijin K.K.) was wound.

Pressing depth: 0.3 mm

Substrate feed rate: 10 cm/sec

Rotation speed: 1000 rpm

Substrate feed: 4 times

Then, on one of the substrates, silica beads (average particle size=1.4 μm) were dispersed and the pair of substrates were applied to each other so that the rubbing treating axes were in parallel with each other but oppositely directed (anti-parallel relationship), thus preparing a blank cell with a uniform cell gap.

In a similar manner, 10 blank cells a1-a10 in total inclusive of the above cell were prepared except for changing a deviation angle θ₁ of 0-45 degrees (positive value in a clockwise direction) of the rubbing direction with respect to data signal line (source line) extension direction shown below.

| Cell | | | | | | | | | | |
|---|---|---|---|---|---|---|---|---|---|---|
| No. | a1 | a2 | a3 | a4 | a5 | a6 | a7 | a8 | a9 | a10 |
| θ₁ | 0 | +5 | +10 | +15 | +20 | +25 | +30 | +35 | +40 | +45 |
| (deg.) | | | | | | | | | | |

The liquid crystal composition LC-1 was injected into each of the above-prepared blank cells a1-a10 in its cholesteric phase state and gradually cooled to a temperature providing chiral smectic C phase to prepare active matrix-type liquid crystal devices A1-A10.

In the above cooling step from Iso to SmC*, each of the devices A1-A20 was subjected to a voltage application treatment such that a DC (offset) voltage of ±2 volts (hereinafter, the devices A1-A10 are referred to as devices A1(+)-A10(+)) was applied in a temperature range of Tc ±2° C. (Tc: Ch-SmC* phase transition temperature) while cooling each device at a rate of 1° C./min.

The thus prepared liquid crystal devices A1(+)-A10(+) were subjected to measurement of a contrast at room temperature and microscopic observation of smectic layer (formation) direction (SLC) and alignment state.

Then, each of the devices A1(+) to A10(+) after the measurement (and observation) was again heated and cooled to be subjected to a voltage application treatment such that a DC voltage of −2 volts (hereinafter, the devices are referred to as devices A1(−) to A10(−) (identical to the devices A1(+) to A10(+) except for the polarity of the applied DC voltage)) was applied similarly as in the case of devices A1(+) to A10(+).

The thus-treated devices A1(−) to A10(−) were evaluated similarly as in the case of devices A1(+) to A10(+).

The results are shown in Table 1 below. In Table 1, SLD (smectic layer direction) angle is taken as a positive value in a clockwise direction based on a scanning signal line (gate line) extension direction.

TABLE 1

| Device | | θ₁ | SLD angle | |
|---|---|---|---|---|
| No. | DC (V) | (deg.) | (deg.) | Contrast |
| A1(+) | +2 | 0 | −20 | 90 |
| A2(+) | ″ | +5 | −15 | 95 |
| A3(+) | ″ | +10 | −10 | 110 |
| A4(+) | ″ | +15 | −5 | 140 |
| A5(+) | ″ | +20 | 0 | 150 |
| A6(+) | ″ | +25 | +5 | 140 |
| A7(+) | ″ | +30 | +10 | 110 |
| A8(+) | ″ | +35 | +15 | 95 |
| A9(+) | ″ | +40 | +20 | 90 |
| A10(+) | ″ | +45 | +25 | 85 |
| A1(−) | −2 | 0 | +20 | 90 |
| A2(−) | ″ | +5 | +25 | 85 |
| A3(−) | ″ | +10 | +30 | 83 |
| A4(−) | ″ | +15 | +35 | 80 |
| A5(−) | ″ | +20 | +40 | 80 |
| A6(−) | ″ | +25 | +45 | 80 |
| A7(−) | ″ | +30 | +50 | 80 |
| A8(−) | ″ | +35 | +55 | 80 |
| A9(−) | ″ | +40 | +60 | 80 |
| A10(−) | ″ | +45 | +65 | 83 |

As a result of observation of the SLD, in all the devices A1(+) to A10(+) and A1(−) to A10(−), it has been found that the smectic (molecular) layers were formed in a direction deviated at an angle of 20 deg. from a direction perpendicular to the rubbing direction.

Further, when the SLD is deviated from the scanning signal line (gate line) extension direction at SLD angle of above 10 deg., as an absolute value, i.e., in the cases of the devices A1(+), A2(+), A8(+) to A10(+) and A1(−) to A10(−), these devices merely provided a lower contrast of 80-95. In these device is, alignment defects were observed as transversal lines lying across the pixels in an oblique direction. The lower contrasts may be attributable to an occurrence of these alignment defects.

On the other hand, the devices A3(+) to A7(+) providing the SLD angle of at most 10 deg. as an absolute value showed a higher contrast of 110-150. In these devices, alignment defects were little observed in each pixel.

According to our study, results similar to those obtained above are also attained in the case where different 20 devices including 10 devices subjected to the positive DC (DC(+)) application and 10 devices subjected to the negative DC (DC(−)) application are used.

As described hereinabove, according to the present invention, in the chiral smectic liquid crystal device, by setting a uniaxial alignment axis (rubbing direction) in a prescribed range (θ₁=at least 10 deg.) so as to provide a SLD (LND) angle within ±10 deg. (with respect to either one of the scanning and data signal lines (gate and source lines), it becomes possible to improve a contrast by suppressing or minimizing an occurrence of alignment defects within the pixels. Further, it is also possible to provide a liquid crystal device capable of effecting gradation display by using a chiral smectic liquid crystal providing a tilting angle relationship of β1>β2, preferably β1>5×β2.

What is claimed is:

1. A liquid crystal device, comprising: a pair of substrates at least one of which is provided with a uniaxial alignment axis, and a chiral smectic liquid crystal disposed between the substrates to form a plurality of pixels arranged in rows and columns;
each pixel being provided with a switching element and an electrode for applying a voltage to the liquid crystal via the switching element,
a matrix of signal lines comprising a plurality of scanning signal lines and a plurality of data signal lines being so arranged that each scanning signal line is disposed along a row of the pixels so as to connect a row of the switching elements provided to the row of the pixels and each data signal line is disposed along a column of the pixels so as to connect a column of the switching elements provided to the column of the pixels, and
the liquid crystal exhibiting a phase transition series on temperature decrease of isotropic phase, cholesteric phase and chiral smectic C phase or of isotropic phase and chiral smectic C phase, wherein
the uniaxial alignment axis is arranged to form an angle of at least 10 degrees with respect to both the scanning signal lines and the data signal lines so that the liquid crystal is aligned to form smectic layers of which a layer extension direction forms an angle of at most 10 degrees with respect to either one of the scanning and data signal lines.

2. A device according to claim 1, wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, and is tilted from the monostable alignment state in the other direction when supplied with a voltage of a second polarity opposite to the first polarity at a tilting angle, said tilting angles providing maximum tilting angles β1 and β2 formed under application of the voltages of the first and second polarities, respectively, satisfying β1>β2.

3. A device according to claim 2, wherein the maximum tilting angles β1 and β2 satisfy β1>5×β2.

4. A device according to claim 1, wherein the liquid crystal has an alignment characteristic such that the liquid crystal is aligned to provide an average molecular axis to be placed in a monostable alignment state under no voltage application, is tilted from the monostable alignment state in one direction when supplied with a voltage of a first polarity at a tilting angle which varies depending on magnitude of the supplied voltage, but is not substantially tilted from the monostable alignment state in the other direction when supplied with a voltage of a second polarity opposite to the first polarity.

5. A device according to any one of claims 1-4, wherein the liquid crystal has a helical pitch in its bulk state larger than a value two times a cell thickness.

6. A device according to any one of claims 1-4, wherein the switching elements comprises thin film transistors.
